(19) United States
(12) Patent Application Publication
(10) Pub. No.: US 2019/0132831 A1
(43) Pub. Date: May 2, 2019

(54) Resource Element-Level Allocation For Wireless Communication

(71) Applicant: Google LLC, Mountain View, CA (US)

(72) Inventors: Erik Richard Stauffer, Sunnyvale, CA (US); Aamir Akram, San Jose, CA (US); Jibing Wang, Saratoga, CA (US)

(73) Assignee: Google LLC, Mountain View, CA (US)

(21) Appl. No.: 15/798,251

(22) Filed: Oct. 30, 2017

(51) Int. Cl. H04W 72/04; H04L 5/00

(52) U.S. Cl. CPC H04W 72/048; H04W 52/0212; H04L 5/0016; H04W 72/042

(57) ABSTRACT

The present disclosure describes apparatuses and methods of resource element-level allocation for wireless communication. In some aspects, a base station of a wireless network determines an amount of information to be transmitted by a wireless device of the wireless network. Based on the determined amount of information, the base station can allocate one or more resource elements of a resource block to the wireless device. The base station then receives, via the allocated one or more resource elements, the information transmitted by the wireless device. At least some other resource elements of the resource block are not allocated to the wireless device for communication of the information. By so doing, the other resource elements of the resource block can be allocated to other wireless devices. This may enable multiple wireless devices to access the wireless network through respective allocations of resource elements of the resource block.

### BACKGROUND

Computing or electronic devices often communicate with other devices or networks via a wireless communication node. The wireless communication node, such as a base station or access point, may provide and manage a wireless network by which the device communicates in accordance with a wireless communication protocol or standard. To facilitate communication via the wireless network, conventional wireless communication nodes typically allocate or assign physical access of wireless spectrum to each device associated with the network. This physical access is often assigned to each of the devices as uniform units of frequency or time, which may be dedicated to or held by a device for prolonged periods of time.

Many wireless devices, however, vary by type and/or mobility, which can affect data consumption and usage patterns for a given device. For example, a streaming media device may consume large amounts of data (e.g., gigabytes) over sustained durations of time. In contrast, a wireless-enabled utility meter may transmit just a few kilobytes of data a few times a month for tracking weekly volumes of water usage. As such, the allocation of uniform units of frequency or time to all devices associated with the wireless network often results in inefficient utilization of the physical access and other resources of the wireless network managed by the wireless communication node.

This inefficient resource block utilization may negatively affect hardware resources of the mobile stations or user devices that transmit smaller amounts of data. For example, spreading transmit power across an allocated resource block can increase in peak-to-average power ratio (PAPR) for the user device, reducing transceiver power efficiency. This may also lead to more power back-off in a power amplifier (PA) of the user device transceiver and result in increased power consumption, which reduces an overall power efficiency of the user device.

### SUMMARY

The present disclosure describes apparatuses and methods of resource element-level allocation for wireless communication. In some aspects, a base station of a wireless network determines an amount of information to be transmitted by a wireless device of the wireless network. Based on the determined amount of information, the base station can allocate one or more resource elements of a resource block to the wireless device. The base station then receives, via the allocated one or more resource elements, the information transmitted by the wireless device. At least some other resource elements of the resource block are not allocated to the wireless device for communication of the information. By so doing, the other resource elements of the resource block can be allocated to other wireless devices, thereby enabling more than one wireless device to communicate using a resource block through which the wireless network is accessed.

In some aspects, a method is described in which a determination is made of an amount of information to be transmitted by a wireless device to a base station. Based on the determined amount of information, one or more resource elements of a resource block are allocated to the wireless device for the transmission of the information. The resource block is a resource block of network access and has other resource elements that are not allocated to the wireless device. A message is then transmitted to the wireless device that indicates the allocated one or more resource elements of the resource block. From the wireless device, the information is received via the allocated one or more resource elements of the resource block.

In other aspects, an apparatus for managing access to a wireless network includes a transceiver, one or more hardware-based processors, and a resource manager implemented at least partially by the one or more hardware-based processors. The resource manager is configured to determine an amount of information to be transmitted by a wireless device to the apparatus. Based on the determined amount of information, the resource manager can allocate one or more resource elements of a resource block to the wireless device. The resource block is a resource block of network access and has other resource elements that are not allocated to the wireless device. The resource manager then transmits, with the transceiver and to the wireless device, a message indicating the allocated one or more resource elements of the resource block. From the wireless device, the resource manager receives, with the transceiver, the information via the allocated one or more resource elements of the resource block.

In yet other aspects, another apparatus for managing access to a wireless network includes a transceiver, one or more hardware-based processors, and a resource manager implemented at least partially by the one or more hardware-based processors. The resource manager is configured to determine an amount of information to be transmitted by a wireless device to the apparatus. Based on the determined amount of information, the resource manager can allocate one or more subcarriers of a resource block to the wireless device. The resource block is a resource block of network access and has other subcarriers that are not allocated to the wireless device. The resource manager then transmits, with the transceiver and to the wireless device, a message indicating the allocated one or more subcarriers of the resource block. From the wireless device, the resource manager receives, with the transceiver, the information via the allocated one or more subcarriers of the resource block.

The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, this summary should not be considered to describe essential features nor used to limit the scope of the subject matter of the appended claims.

### BRIEF DESCRIPTION OF THE DRAWINGS

The details of one or more aspects of resource element-level allocation for wireless communication. The use of the same reference numbers in different instances in the description and the figures may indicate like elements:

FIG. 1 illustrates an example operating environment that includes a base station capable of implementing one or more aspects of resource element-level allocation.

FIG. 2 illustrates an example network environment in which resource elements of a resource block are allocated based on frequency.

FIG. 3 illustrates an example network environment in which resource elements of a resource block are allocated based on time or symbols.

FIG. 4 illustrates an example method for allocating resource elements of a resource block in accordance with one or more aspects.

FIG. 5 illustrates an example method for transmitting data using one or more resource elements allocated for a transmission time interval.

FIG. 6 illustrates an example method for scheduling resource elements allocated to multiple wireless device for a particular transmission time interval.

FIG. 7 illustrates an exemplary configuration of a communication controller in which a resource manager for resource element-level allocation can be implemented.

### DETAILED DESCRIPTION

Wireless communication nodes often allocate resource blocks of network access (e.g., bandwidth and time) managed by the wireless communication node via a scheduler. Conventional schedulers typically allocate entire resource blocks of network access, including all subcarriers and time subintervals, to a device associated with a wireless network of the communication node. For example, with most wireless communication protocols, such as the 3rd Generation Partnership Project Long-Term Evolution (3GPP LTE) protocol, the scheduler often allocates all bandwidth and time of a given resource block to a user device for communicating information within the wireless network.

With respect to LTE and similar protocols, a resource block of network access may include subcarriers, where each subcarrier (i) spans a portion of the specified bandwidth and (ii) includes resource elements corresponding to subintervals of the specified time interval. In the case of LTE, a resource block can span a bandwidth of 180 kilohertz (kHz) for a time interval of one-half millisecond (ms). Frequency-wise, a resource block in LTE may include 12 subcarriers that each span a bandwidth of 15 kHz for the one-half millisecond of time (12×15 kHz=180 kHz). Further the one-half millisecond or time slot may comprise 7 symbols for a normal cyclic prefix or 6 symbols for an extended cyclic prefix. As such, each resource block may include 84 resource elements defined by the 12 subcarriers (frequency) and 7 symbols (time).

As described, a conventional scheduler typically allocates an entire resource block, including all subcarriers and time intervals, respectively to each device communicating in the wireless network. When a device communicates less than a maximum amount of data supported by a resource block, however, at least some of that allocated network or spectrum access is wasted. Further, this inefficient resource block utilization may negatively affect hardware resources of the mobile stations or user devices that transmit smaller amounts of data. For example, spreading transmit power across an allocated resource block can increase in peak-to-average power ratio (PAPR) for the user device. This may lead to more power back-off in a power amplifier (PA) of the user device transceiver and result in increased power consumption, which reduces an overall power efficiency of the user device.

The present disclosure describes aspects of resource element-level allocation for wireless communication, which can enable more-efficient use of wireless spectrum or other network resources. For example, a resource block of network access may be allocated at various granularities and/or to multiple wireless device in order to support communication of different amounts of information. Such allocations can be made at a resource element-level, in frequency and/or time, enabling subcarriers or spreading codes within the resource block to be allocated to at the resource element-level to a device or among multiple devices.

In some aspects, a base station of a wireless network determines an amount of information to be transmitted by a wireless device of the wireless network. Based on the determined amount of information, the base station can allocate one or more resource elements of a resource block to the wireless device. The base station then receives, via the allocated one or more resource elements, the information transmitted by the wireless device. At least some other resource elements of the resource block are not allocated to the wireless device for communication of the information. By so doing, the other resource elements of the resource block can be allocated to other wireless devices, thereby enabling more than one wireless device to communicate using a resource block through which the wireless network is accessed. Further, the allocation at the resource element-level may also decrease PAPR for a user device, increasing transceiver power efficiency. Alternately or additionally, power back-off in the PA the user device transceiver can be decreased, resulting in an improved power efficiency for the user device.

These and other aspects of resource element-level allocation may also improve wireless network performance when supporting devices that transmit small amounts of information or data, such as Internet-of-Things (IoT) devices. Through the implementation of apparatuses and methods described throughout the disclosure, network access may be more-efficiently allocated, scheduled, or otherwise distributed such that multiple wireless devices are able to utilize one resource block for network access. By so doing, a capacity of the wireless network may be extended to better serve more devices or devices at extended ranges where resource element-level allocation permits improved transmitter performance.

The following discussion describes an operating environment, techniques that may be employed in the operating environment, and a resource manager in which components of the operating environment can be embodied. In the context of the present disclosure, reference is made to the operating environment by way of example only.

Operating Environment

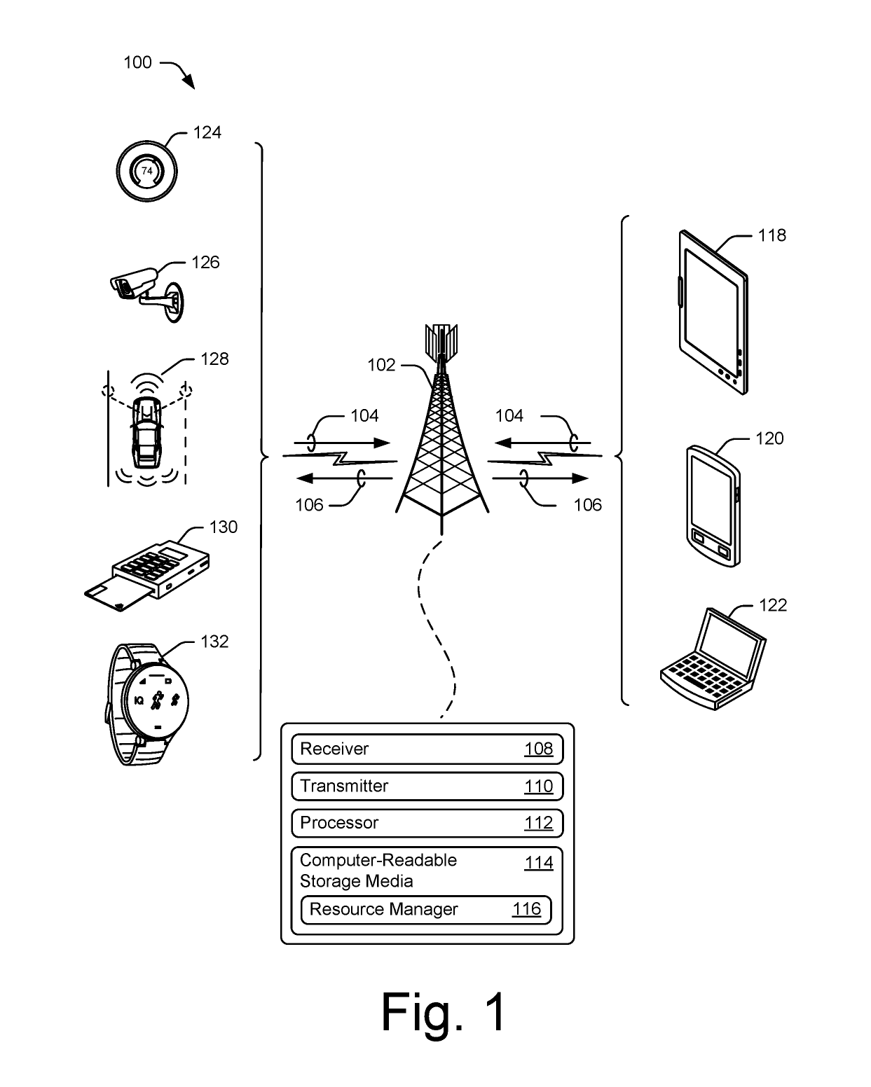

FIG. 1 illustrates an example operating environment 100 which includes a base station 102 that communicates with various wireless devices in accordance with one or more aspects. The base station 102 may receive, from a wireless device, information via a wireless uplink (UL) 104 and transmit, to the wireless device, other information via a wireless downlink (DL) 106. In some cases, the information is relayed between wireless devices of a wireless network. In other cases, the wireless devices access information of a network (e.g., internet) or resource via a wireless network provided by the base station 102. The wireless uplink 104 and/or wireless downlink 106 may be configured to adhere to various wireless communication protocols, including a Global System for Mobile Communications (GSM) protocol, a Third Generation (3G) protocol, a Worldwide Interoperability for Microwave Access (WiMax) protocol, a High Speed Packet Access (HSPA) protocol, an Evolved HSPA (HSPA+) protocol, a Long-Term Evolution (LTE) protocol, an LTE Advanced protocol, a Fifth Generation (5G) protocol, and the like.

In this example, the base station 102 is embodied generally as a cellular base station, and may be implemented as any suitable type of network management node, such as a GSM base station, an Enhanced NodeB (eNB) base station, a gNodeB (gNB) base station, a cellular hotspot, a broadband router, or the like. The base station 102 includes at least one receiver 108 and at least one transmitter 110 for communicating with wireless devices of the wireless network. Alternately or additionally, transmitter or receiver circuitry of the base station 102 may be configured or combined as a transceiver or transceiver circuitry with respective transmit and receive chains.

The base station 102 includes one or more processors 112 for executing processor-executable instructions or code stored on a computer-readable storage media (CRM) 114 to implement various functions of the base station 102. In some cases, the processor 112 is implemented as an application processor (e.g., multicore processor) or a system-on-chip with other components of the base station 102 integrated therein. The CRM 114 may include any suitable type of memory media or storage media, such as read-only memory (ROM), programmable ROM (PROM), random access memory (RAM), static RAM (SRAM), or Flash memory. In the context of this discussion, the CRM 114 of the base station 102 is implemented as hardware-based storage media, which does not include transitory signals or carrier waves. In some cases, the CRM 114 stores firmware, an operating system, and/or applications of the base station 102 as instructions, code, or information. The instructions or code can be executed by the processor 112 to implement various functionalities of the base station 102, such as those related to allocating and scheduling network access for wireless devices. In this example, the CRM 114 also stores processor-executable code or instructions for implementing the resource manager 116 of the base station 102.

In the context of the operating environment 100, the base station 102 may support or manage communication with one or more wireless devices (e.g., user devices), or other networks connected to the base station (e.g., via a backhaul link, not shown). Example wireless devices may include any suitable type of device, such as a tablet 118, a smart phone 120, or a laptop 122, which may be configured as full-featured devices having native displays, user interfaces, and/or batteries for sustained network access. Other example wireless devices include a smart-home environmental control system 124, a security camera 126, an Advanced Driver Assistance System (ADAS) 128, a point-of-sale (POS) transaction system 130, or a health monitoring device 132 that has a positioning system (GPS). These other devices may be configured as Internet-of-things (IoT) or low-power devices, which have reduced computational resources compared to full featured wireless devices and/or consume reduced amount of data via the wireless network.

In some aspects, the wireless devices may communicate in pairs, with data or other information relayed by the base station 102. The communication between a pair of communicating wireless devices may be bi-directional in directional, where the pair of communicating wireless devices may change roles to either transmit or receive information via the base station 102. Alternately or additionally, the base station 102 may provide network access to multiple wireless devices, such that physical resources of the wireless network are allocated by the resource manager among the wireless devices. Furthermore, and in addition to the illustrated example of the wireless devices 118-132, the base station 102 may also communicate with or manage other various wirelessly-enabled devices, such as automation equipment, a drone, a camera, a wearable smart-device, a gaming device, a personal media device, a navigation device, a mobile-internet device (MID), a network-attached-storage (NAS) drive, a mobile gaming console, and so on.

The resource manager 116 of the base station 102 can be implemented to perform various functions associated with allocating and/or scheduling access to resources (e.g., wireless spectrum) available to the base station 102. For example, the resource manager 116 may determine respective amounts of information to be communicated by one or more of the wireless devices. Based on the determination, the resource manager 116 may allocate a resource elements or subcarriers of a resource block of network access to respective one of the wireless devices. The resource manager 116 may further schedule resource elements or subcarriers at specific transmission time intervals (TTIs) within each frame or time interval of network access. Based on the allocating and/or scheduling, the resource manager 116 may then transmit, to the wireless devices, a message that indicates resource element allocation and scheduling details that enable the wireless device to communicate with the base station 102. For example, the resource manager 116 may transmit a Radio Resource Control (RRC) message or Downlink Control Information (DCI) message to the wireless device that includes a field that indicates a subcarrier, a spreading code, a location (e.g., offset within the resource block), a TTI for, or a number of the allocated one or more resource elements.

Any wireless device or multiple wireless devices, such as the wireless devices 118-132, may also provide an indication of an amount of data to be communicated or a context to the resource manager 116. In some cases, this indication of an amount of data or context may be useful to the resource manager 116 in determining how many resource elements to allocate to a wireless device. The context can be provided as part of a preamble of a communication packet and/or indicate a type of information being transmitted by the wireless device. A particular type of information may be associated with a respective amount of information likely to be communicated by the wireless device. For example, if the type of information is associated with a smart-home environmental control system, security or surveillance system, vehicle monitor or controls system, a retail transaction, a global positioning system (GPS), the resource manager 116 may determine that a minimal amount of network resources is necessary to communicate such information. With the determination, the resource manager 116 can then allocate and/or schedule a minimum or near minimum quantity of resource elements to support communication of the information. Alternately or additionally, if the preamble includes an indication of the amount of information to be communicated, the resource manager 116 may allocate and/or schedule a minimum or near minimum quantity of resource elements to support the communication of the indicated amount information.

Information or device context may also be available to the resource manager 116 through one or more other indications or techniques. For example, context may be provided via a wireless device identifying itself to the base station 102 as an Internet-of-Things (IoT) type of device. The base station 102 may also poll wireless devices for context or a device type over an area or region for which the base station 102 provides wireless network access. Alternately or additionally, the resource manager 116 may derive context based on historical trends or data collected from the wireless devices over time. Once known or determined, a context may be associated with a particular wireless device, such as by linking the context with a unique identifier of the wireless device (e.g., IP address or mobile subscriber identifier).

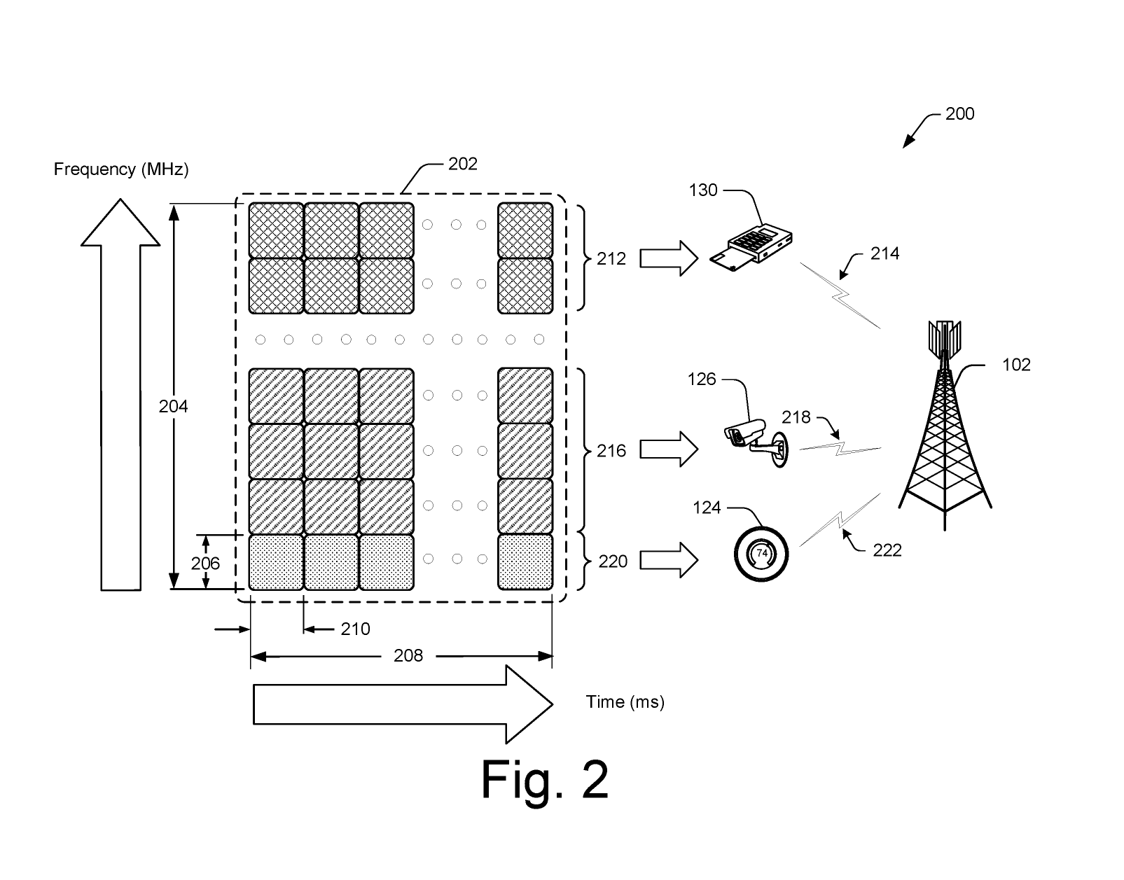

FIG. 2 illustrates an example networking environment 200 in which resource elements of a resource block can be allocated by frequency or subcarrier. As illustrated at 200, a resource block 202 of network access may be allocated to support respective communication of multiple wireless devices, such as those of the operating environment 100. The resource block 202 of network access may span, as defined by a communication protocol, a specified frequency range 204 and comprise of a plurality of subcarriers. The resource block may include any suitable number of subcarriers (e.g., 12) that each a respective portion 206 (e.g., 15 kHz) of the specified frequency range 204 (e.g., 180 kHz). The resource block 202 of network access may also span, as defined by a communication protocol, a specified time interval 208 or time slot. The time interval 208 includes subintervals 210 that may correspond to symbols, such as orthogonal frequency-division multiplexing (OFDM) symbols. As shown in FIG. 2, the resource block 202 may include a plurality of resource elements that correspond or defined by a subcarrier 206 and subinterval 210 (or symbol).

In this example, multiple wireless devices are communicating with the base station 102 through access provided by the resource block 202. Specifically, the base station 102 is communicating with the POS transaction system 130, security camera 126, and smart-home environmental control system 124. In some aspects, the resource manager 116 may determine a respective type or amount of information (e.g., data) to be communicated (e.g., transmitted) by each of the POS transaction system 130, security camera 126, and smart-home environmental control system 124.

For example, the resource manager can determine that the POS transaction system 130, security camera 126, and smart-home environmental control system 124 will each transmit a different respective amount of information. Based on the determinations, the resource manager 116 may then allocate two adjacent subcarriers 212 to the POS transaction system 130 to support the transmission of information via uplink 214. As illustrated, any or all communication links may include an uplink (UL) and/or downlink (DL) to support communication between the base station 102 and a wireless device (e.g., user device).

In contrast with conventional resource block-level scheduling, the resource manager 116 may allocate other subcarriers or resource elements of the resource block 202 to other wireless devices. Here, the resource manager 116 allocates three subcarriers 216 to the security camera 126 for communication link 218, and a single subcarrier 220 to the smart-home environmental control system 124 for communication link 222. By so doing, one resource block can be allocated to facilitate network access for multiple wireless devices. Accordingly, the resource manager 116 may allocate, at various granularities, up to all subcarriers or resource elements of a resource block to multiple wireless devices, thereby enabling higher network utilization or increased spectrum efficiency.

Based on the allocated subcarriers 212, 216, and 220, the resource manager 116 can then transmit respective messages indicative of the allocation to each of the wireless devices. Such a message may enable or be useful to the wireless device to queue the information or configure a transceiver to communicate via the allocated subcarrier or resource element. In this example, the POS transaction system 130, security camera 126, and smart-home environmental control system 124 can respectively transmit information to the base station 102 via the allocated subcarriers 212, 216, and 220. Alternately or additionally, the base station 102 may communicate, via the allocated subcarriers 212, 216, and/or 220, other information to one or more other wireless devices using the communication links 214, 218, and 222.

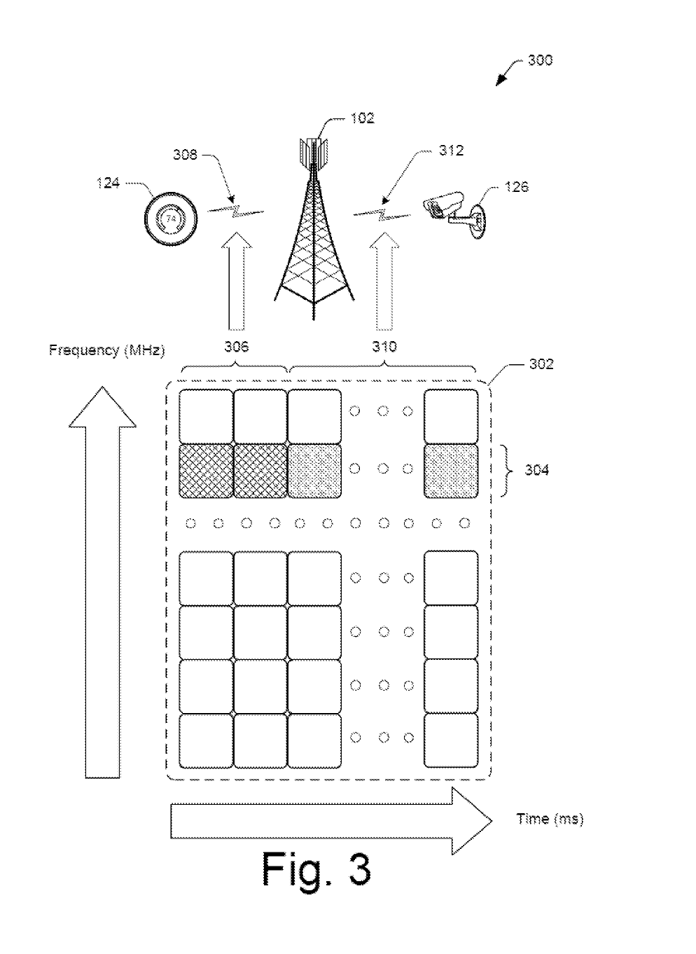

FIG. 3 illustrates another example networking environment 300 in which resource elements of a resource block can be allocated by symbol, time subinterval, or spreading code. As illustrated at 300, a resource block 302 of network access may be allocated to support respective communication of multiple wireless devices, such as those of the operating environment 100 of FIG. 1. As described herein, the resource block 302 may be divisible by frequency and/or time into resource elements of network access that may be allocated to one or more wireless devices.

Multiple wireless devices, such as the smart-home environmental control system 124 and security camera 126, may communicate or access any suitable type of information via the base station 102 or wireless network provided thereby. In some aspects, the resource manager 116 may determine respective amounts of information to be communicated by the smart-home environmental control system 124 (e.g., temperature information) and the security camera 126 (e.g., motion or proximity alert). Based on the determination, the resource manager 116 can then allocate resource elements of a subcarrier 304 (e.g., by symbol or spreading code) to support the communication of the information of the smart-home environmental control system 124 and security camera 126.

Based on the allocation, the resource manager 116 may schedule the resource elements of the subcarrier 304 to support different communication links at different transmission time intervals or different spreading codes. In this example, resource elements 306 of the subcarrier 304 are scheduled to support communication link 308 (e.g., for the smart-home environmental control system 124) with a first spreading code and resource elements 310 of subcarrier 304 are scheduled to support communication link 312 (e.g., for the security camera 126) with a second spreading code. Scheduling of the resource elements 306 and the resource elements 310 may rely, at least in part, on a spreading algorithm or spreading code pattern to enable sharing of the subcarrier 304 between the smart-home environmental control system 124 and security camera 126, and/or other wireless devices (not shown).

Based on the allocation of resource elements of the subcarrier 304 (resource block 302), the resource manager 116 can transmit respective messages to the wireless devices 124 and 126 indicating the respective allocation of resource element to each device. Such a message may enable or be useful to the wireless device to queue the information or configure a transceiver to communicate via the allocated resource elements of the resource block. In this example, the smart-home environmental control system 124 and security camera 126 can respectively transmit information to the base station 102 via the allocated resource elements 306 and 310. Alternately or additionally, the base station 102 may communicate, via the allocated resource elements 306 and 310, other information to one or more other wireless devices using the communication links 308 and 312.

By so doing, the resource manager 116 may allocate one resource block or one subcarrier at a resource element-level to facilitate network access for multiple wireless devices. Accordingly, the resource manager 116 may allocate, at various granularities, up to all subcarriers or resource elements of a resource block to multiple wireless devices, thereby enabling higher network utilization or increased spectrum efficiency.

Techniques of Resource Element-Level Allocation

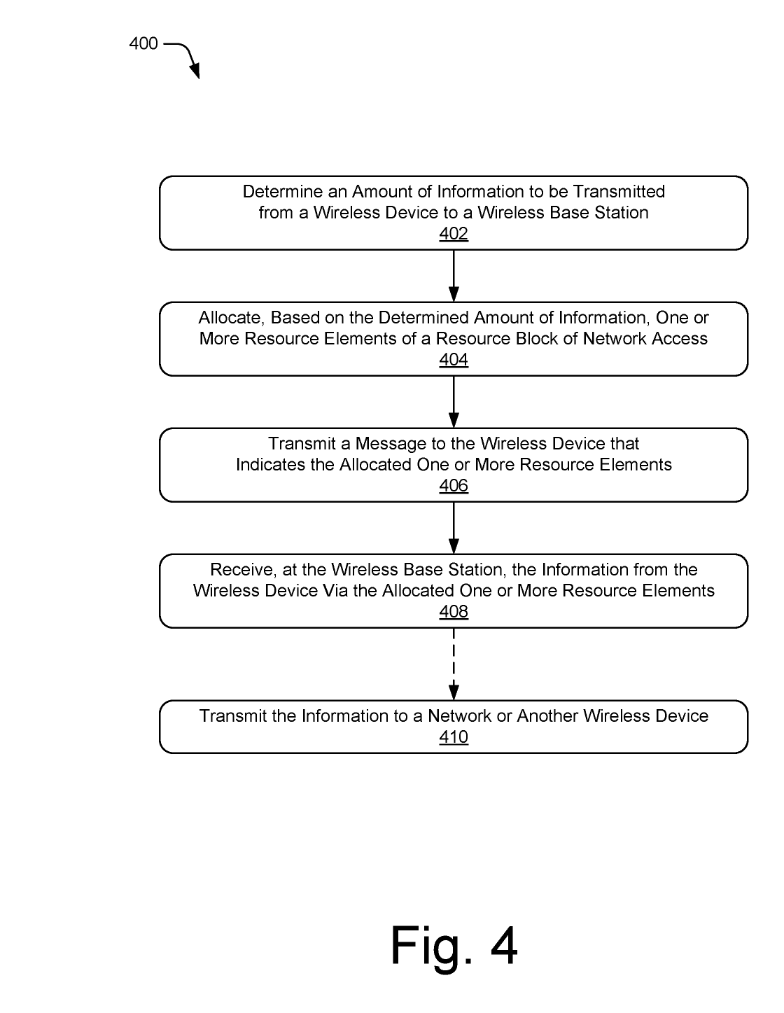

FIGS. 4-6 depict methods of resource element-level allocation for wireless communication. These methods are shown as sets of blocks that specify operations performed but are not necessarily limited to the order or combinations shown for performing the operations by the respective blocks. For example, operations of different methods may be combined, in any order, to implement alternate methods without departing from the concepts described herein. In portions of the following discussion, the techniques may be described in reference may be made to entities of FIGS. 1-3 or FIG. 7, reference to which is made by way example only. The techniques are not limited to performance by one entity or multiple entities operating on one device, or those described in these figures.

FIG. 4 illustrates an example method 400 for allocating resource elements of a resource block in accordance with one or more aspects, including operations performed by the resource manager 116. In some aspects, operations of the method 400 may be implemented at or by a base station to improve spectrum efficiency of a wireless network.

At 402, an amount of information to be transmitted by a wireless device is determined. In some cases, the amount of information is determined based on a message received from the wireless device that indicates a context of the information, an amount of requested bandwidth, a type of information, or the amount of the information. Alternately or additionally, the amount of information to be transmitted may be estimated based on previous transmissions of information received from one of the wireless device, a similarly configured wireless device, or another wireless device of a same or similar type.

At 404, one or more resource elements of a resource block are allocated to the wireless device based on the determined amount of information. The resource block may be a resource block of network or physical access specified in terms of frequency and time. In some cases, the one or more resource elements are allocated as one or more subcarriers of the resource block. In such cases, two or more of the subcarriers may be allocated as adjacent subcarriers of the resource block. In yet other cases, the one or more resource elements can be allocated by time subinterval, symbol, or spreading code, such as a spreading code that is orthogonal to other spreading codes used to allocate other resource elements. Alternately or additionally, the one or more resource elements of the resource block may be allocated based on a type or identifier associated with the wireless device.

At 406, a message is transmitted to the wireless device that indicates the allocated one or more resource elements of the resource block. The message may be configured as or with any suitable type of message, such as a Radio Resource Control (RRC) message or a Downlink Control Information (DCI) message. In some cases, the message includes a field or indication useful by the wireless device to identify the allocated resource elements by a subcarrier, a spreading code, a location, or a number of the allocated one or more resource elements. When allocating other resource elements of the resource block to other wireless device, additional respective messages may also be transmitted to the other wireless device that identify each device's allocation of the one or more other resource elements.

At 408, the information is received from the wireless device via the allocated one or more resource elements of the resource block. The information may be received through resource elements of a subcarrier or spreading code that is allocated to the wireless device. In some cases, other information is also received from other wireless device via other resource elements of the resource block. By so doing, the resource level-allocation of resource elements may improve a utilization efficiency of the resource block.

Optionally at 410, the information can be transmitted to a network (e.g., the Internet) or another wireless device. For example, if the information is an alert or data associated with a cloud-based application, the base station may transmit or route the information to the application via the Internet or another network. Alternately or additionally, the base station may transmit the information to another wireless device of the wireless network.

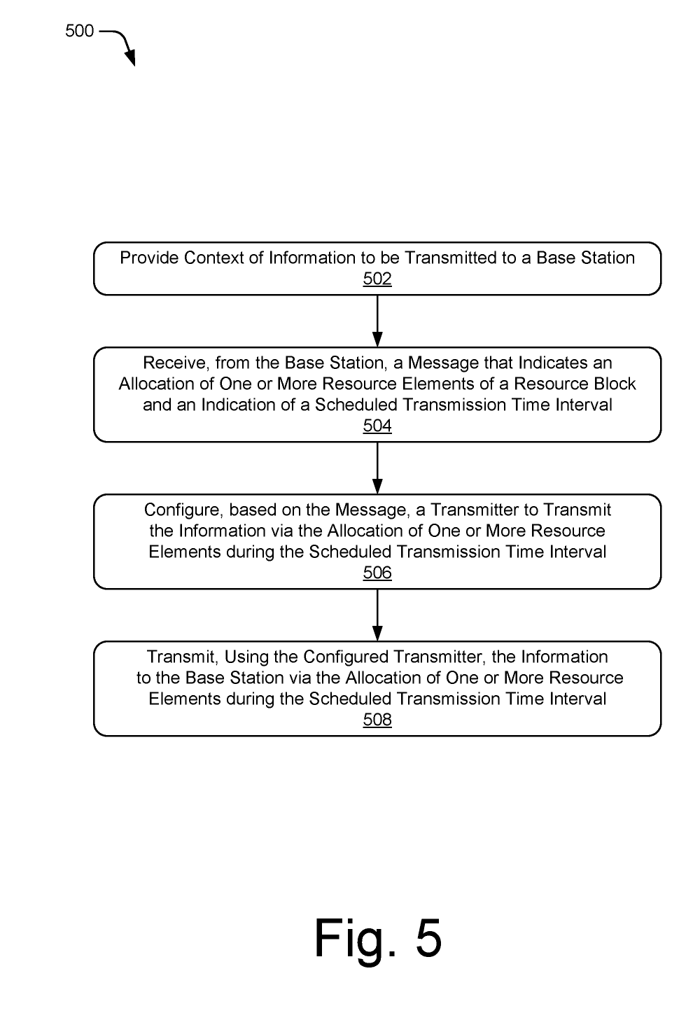

FIG. 5 illustrates an example method 500 for transmitting data using one or more resource elements allocated for a transmission time interval, including operation performed by user devices and/or facilitated by the resource manager 116.

At 502, context of information to be transmitted is provided to a base station. The context can be provided as part of a preamble of a communication packet or data packet transmitted from a wireless device to the base station. The context provided may indicate a type of information being transmitted by the wireless device or a type of the wireless device transmitting the information. In some cases, a particular type of information, such as alerts or sensor information, may be associated with a respective amount of information likely to be communicated by the wireless device. Alternately or additionally, the wireless device may indicate an amount of data to be transmitted or request an amount of bandwidth to facilitate communication of the information.

At 504, a message is received from the base station that indicates an allocation of one or more resource elements of a resource block. The message may also indicate a transmission time interval for which the allocation of the resource block is schedule. In some cases, the message may be received from a base station as part of an RRC message or a DCI message. Alternately or additionally, the message may include a field or indication of a subcarrier, a spreading code, or a location (e.g., offset within the resource block) of the allocated resource elements. Such a field or indication by be used by the wireless device to determine which resource elements of a resource block are allocated to the wireless device.

At 506, a transmitter of the wireless device is configured based on the message to transmit the information via the allocation of the one or more resource elements. In some cases, the transmitter (or transceiver) is configured to transmit the information via one or more subcarriers of the resource block. In other cases, the transmitter may be configured to transmit the information using a spreading code that is orthogonal to other spreading codes that may be used in the resource block. Alternately or additionally, other subcarriers or other spreading codes of the resource block may be allocated to other wireless devices of the wireless network.

At 508, the information is transmitted to the base station using the configured transmitter and via the allocation of one or more resource elements. The information may also be transmitted during the scheduled transmission time interval for the resource block. In some cases, operations of method 500 may be repeated to transmit information in a subsequent resource block or transmission time interval. In such cases, the wireless device may request to use a same subcarrier or spreading code across two or more resource blocks. Alternately or additionally, a resource manager of the base station may semi-statically assign particular subcarriers or spreading codes to respective wireless devices. This may be effective to reduce communicative overhead or transmitter configuration for communications across multiple resource blocks.

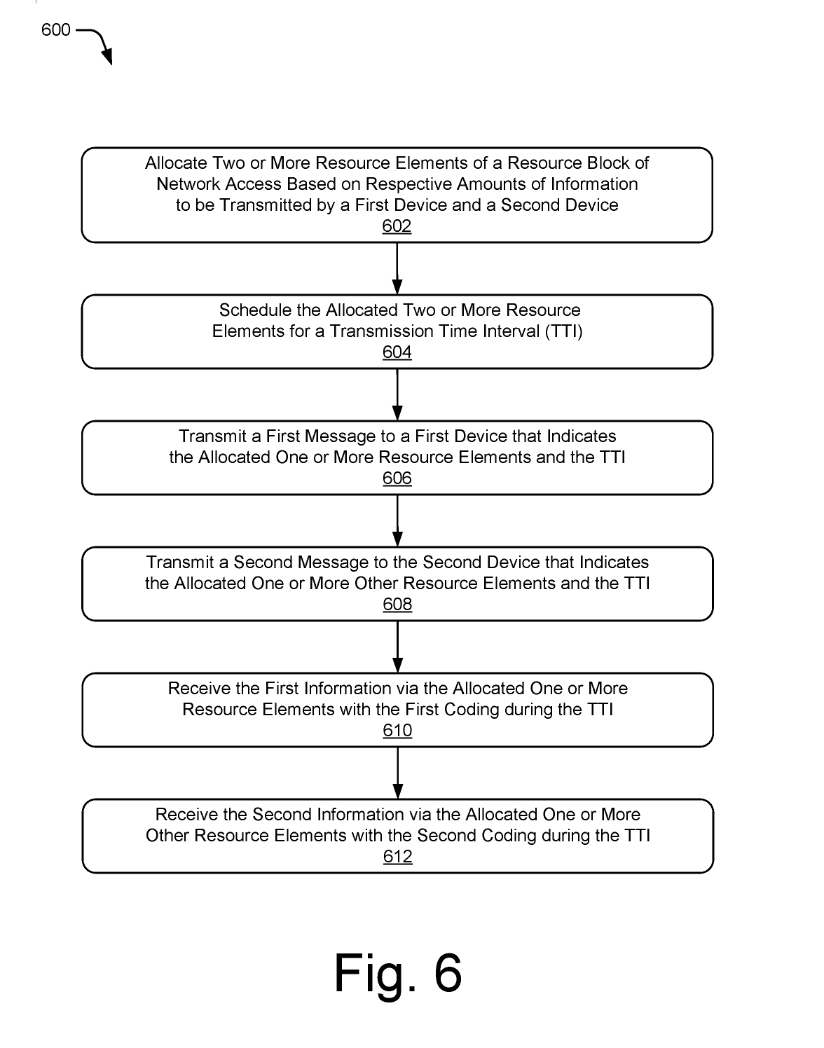

FIG. 6 illustrates an example method for scheduling resource elements allocated to multiple wireless device for a particular transmission time interval, including operations performed by the resource manager 116. In some aspects, operations of the method 600 may be implemented at or by a base station to improve spectrum efficiency of a wireless network.

At 602, two or more resource elements of a resource block of network access are allocated based on respective amounts of information to be transmitted by a first device and second device. The resource elements of the resource block can be allocated between the first device and the second device based on the respective amounts of information or a context of the information or device. For example, one or more subcarriers of the resource block can be allocated to the first device and one or more other subcarriers of the resource block can be allocated to the second device. In such cases, two or more of the subcarriers can be allocated as adjacent subcarriers of the resource block or in frequency domain. Alternately or additionally, the resource elements of the resource block can be allocated between the two devices using different spreading codes.

At 604, the two or more allocated resource elements of the resource block are scheduled for a transmission time interval. This may include scheduling allocated resource elements of a first subcarrier for use by the first device and scheduling allocated resource elements of a second subcarrier for use by the second device. Alternately or additionally, one or more resource elements may be scheduled for the first device with a first spreading code and one or more other resource elements may be scheduled for the second device with a second spreading code.

At 606, a first message is transmitted to the first device that indicates the allocated one or more resource elements of the first device and the transmission time interval. The first message may be transmitted as an RRC message or a DCI message via a downlink control channel (e.g., physical downlink control channel) or downlink frame. Alternately or additionally, the first message may include a field or indication of a subcarrier, a spreading code, or a location (e.g., offset within the resource block) of the one or more resource elements allocated for the first device.

At 608, a second message is transmitted to the second device that indicates the allocated one or more other resource elements of the second device and the transmission time interval. The second message may be transmitted as an RRC message or a DCI message via a downlink control channel or downlink frame. Alternately or additionally, the second message may include a field or indication of another subcarrier, another spreading code, or another location (e.g., offset within the resource block) of the one or more other resource elements allocated for the second device.

At 610, the first information is received from the first device via the allocated one or more resource elements of the resource block. The first information is also received during or in accordance with the transmission time interval for which the resource block is scheduled. In some cases, the first information is received via one or more subcarriers of the resource block from which the resource elements are allocated for the first device. Alternately or additionally, the first information may be received with a first spreading code that is different from or orthogonal to other spreading codes that may be assigned to other wireless devices.

At 612, the second information is received from the second device via the allocated one or more other resource elements of the resource block. The second information is also received during or in accordance with the transmission time interval for which the resource block is scheduled. In some cases, the second information is received via one or more other subcarriers of the resource block from which the other resource elements are allocated for the second device. Alternately or additionally, the second information may be received with a second spreading code that is different from or orthogonal to other spreading codes (e.g., the first spreading code) that may be assigned to other wireless devices.

Communication Controller

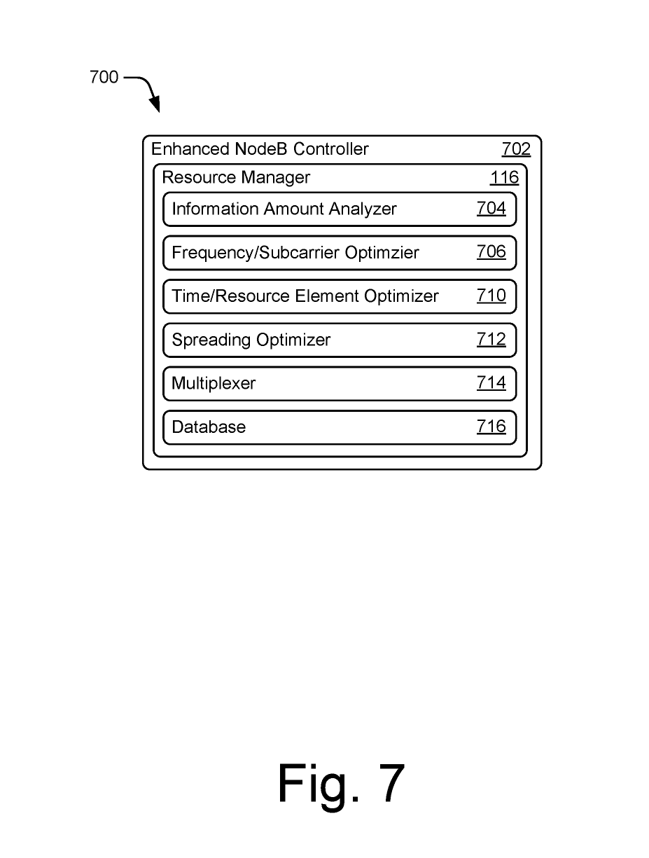

FIG. 7 illustrates an exemplary configuration 700 of an enhanced nodeB controller 702 in which a resource manager 116 can be implemented. The enhanced nodeB controller 702 may include any suitable combination of components, hardware, circuitry, firmware, or software for implementing the resource manager 116. For example, resource manager 116 may be implemented by executing code or instructions from computer-readable media of the enhanced nodeB controller 702, such as one or more memory devices that enable persistent and/or non-transitory data storage (i.e., in contrast to mere signal transmission). These memory devices may include random access memory (RAM), non-volatile memory (e.g., any one or more of a read-only memory (ROM), flash memory, EPROM, EEPROM, etc.), disk storage device, or the like.

In this example, the resource manager 116 also includes components that can be used to implement one or more aspects of resource element-level allocation for wireless communication. These components may include an information amount analyzer 704, a frequency/subcarrier optimizer 706, a time/resource element optimizer 708, a spreading optimizer 710, a multiplexer 712, and a database 714. Any or all of the components may be implemented as part of the resource manager 116, such as through instructions or code that are executable by a processor of the enhanced nodeB controller 702 to implement respective functionalities of the component 704-716.

In some aspects, the resource manager 116 accesses one or more of the components when determining an amount of information that a wireless device will communicate or a number of resource elements to allocate to the wireless device. The resource manager 116 may also use one or more of the components when determining which subcarriers or spreading codes to select when allocating or scheduling resource elements to a wireless device. Alternately or additionally, the enhanced nodeB controller 702 may include a transceiver interface (not shown) for managing functions of a base station transceiver to implemented respective uplinks, downlinks, and the communication of messages with one or more wireless devices of the wireless network.

Although apparatuses and methods of resource element-level allocation for wireless communication have been described in language specific to features and/or methods, it is to be understood that the subject of the appended claims is not necessarily limited to the specific features or methods described. Rather, the specific features and methods are disclosed as example ways in which radar-based contextual sensing can be implemented.

1. A method performed by a base station of a wireless network, the method comprising:
determining an amount of information to be transmitted by a wireless device to the base station;
allocating, based on the determined amount of information, one or more resource elements of a resource block to the wireless device for the transmission of the information, the resource block being a resource block of network access and having other resource elements available for allocating to other wireless devices to improve performance of the wireless network;
transmitting, to the wireless device, a message indicating the allocated one or more resource elements of the resource block, the allocated one or more resource elements improving a power efficiency of the user device; and
receiving, from the wireless device, the information via the allocated one or more resource elements of the resource block.

2. The method as recited by claim 1, wherein allocating the one or more resource elements of the resource block allocates one or more subcarriers of the resource block to the wireless device.

3. The method as recited by claim 2, further comprising allocating one or more other subcarriers of the resource block to another wireless device for transmission of other information.

4. The method as recited by claim 2, wherein allocating the one or more subcarriers of the resource block allocates at least two of the subcarriers of the resource block that are adjacent to one another in frequency.

5. The method as recited by claim 1, wherein allocating the one or more resource elements of the resource block allocates the one or more resource elements with a same spreading code.

6. The method as recited by claim 5, wherein the spreading code is a first spreading code and the method further comprises allocating one or more of the other resource elements of the resource block to another wireless device with a second spreading code for transmission of other information.

7. The method as recited by claim 1, wherein the message that indicates the allocated one or more resource elements is transmitted as part of a Radio Resource Control (RRC) message or Downlink Control Information (DCI) message.

8. The method as recited by claim 7, wherein the RRC message or the DCI message includes a field with information useful to identify a subcarrier, a spreading code, a location, or a number of the allocated one or more resource elements of the resource block.

9. The method as recited by claim 1, further comprising receiving, from the wireless device, an indication of a type of information to be transmitted, and wherein the amount of information to be transmitted is determined based at least in part on the type of the information.

10. An apparatus for managing access to a wireless network comprising:
a transceiver;
one or more hardware-based processors; and
a resource manager implemented at least partially by the one or more hardware-based processors, the resource manager configured to execute processor-executable code to:
determine an amount of information to be transmitted by a wireless device to the apparatus;
allocate, based on the determined amount of information, one or more resource elements of a resource block to the wireless device, the resource block being a resource block of network access and having other resource elements available for allocating to other wireless devices to improve performance of the wireless network;
transmit, with the transceiver and to the wireless device, a message indicating the allocated one or more resource elements of the resource block, the allocated one or more resource elements improving a power efficiency of the user device; and
receive, with the transceiver and from the wireless device, the information via the allocated one or more resource elements of the resource block.

11. The apparatus of claim 10, wherein the allocated one or more resource elements are resource elements of one or more subcarriers of the resource block.

12. The apparatus of claim 11, wherein the resource manager is further configured to allocate one or more other subcarriers of the resource block to another wireless device for transmission of other information.

13. The apparatus of claim 10, wherein the allocated one or more resource elements of the resource block are allocated with a same spreading code.

14. The apparatus of claim 13, wherein the spreading code is a first spreading code and the resource manager is further configured to allocate one or more of the other resource elements to another wireless device with a second spreading code for transmission of other information.

15. The apparatus of claim 10, wherein the resource manager is further configured to receive, from the wireless device, indication of a type of the information to be transmitted by the wireless device or an amount of the information to be transmitted by the wireless device.

16. The apparatus of claim 15, wherein the type of the information to be transmitted is associated with or facilitates operation of one of:
an environmental control system;
a security system;
a surveillance system;
a vehicle monitoring or control system;
a retail transaction system; or
a global positioning system.

17. An apparatus for managing access to a wireless network comprising:
a transceiver;
one or more hardware-based processors; and
a resource manager implemented at least partially by the one or more hardware-based processors, the resource manager configured to execute processor-executable code to:
determine an amount of information to be transmitted by a wireless device to the apparatus, the determination based on a context available to the resource manager that identifies the wireless device to be an Internet-of-Things (IoT) type of device;
allocate, based on the determined amount of information, one or more subcarriers of a resource block to the wireless device, the resource block being a resource block of network access and having other subcarriers that are not allocated to the wireless device;
transmit, with the transceiver and to the wireless device, a message indicating the allocated one or more subcarriers of the resource block, the allocated one or more resource elements improving a power efficiency of the user device; and
receive, with the transceiver and from the wireless device, the information via the allocated one or more subcarriers of the resource block.

18. The apparatus of claim 17, wherein the resource manager is further configured to:
receive, from the wireless device,
the context.

19. The apparatus of claim 17, wherein the resource manager is further configured to allocate at least one of the other subcarriers of the resource block to another wireless device for transmission of other information.

20. The apparatus of claim 17, wherein the message that indicates the allocated one or more subcarriers is transmitted as part of a Radio Resource Control (RRC) message or Downlink Control Information (DCI) message having information that is useful to identify a location or number of the allocated one or more subcarriers within the resource block.
